(19) United States
(12) Patent Application Publication
(10) Pub. No.: US 2023/0281525 A1
(43) Pub. Date: Sep. 7, 2023

(54) SYSTEMS AND METHODS FOR DETERMINING CREW ROSTERS FOR TRIPS

(71) Applicant: THE BOEING COMPANY, Arlington, VA (US)

(72) Inventors: Carl Fredrik Altenstedt, Mölndal (SE); Martin Andersson, Jonsered (SE); Lennart Bengtsson, Göteborg (SE); Waldemar Kocjan, Göteborg (SE); Christoffer Sandberg, Tranås (SE); Dmitrii Sergejev, Mölndal (SE)

(73) Assignee: THE BOEING COMPANY, Arlington, VA (US)

(21) Appl. No.: 18/298,511

(22) Filed: Apr. 11, 2023

Related U.S. Application Data
(63) Continuation-in-part of application No. 17/683,458, filed on Mar. 1, 2022.

(51) Int. Cl. G06Q 10/0631

(52) U.S. Cl. CPC G06Q 10/06311

(57) ABSTRACT

A system and a method include one or more control units including one or more processors. The control unit(s) is configured to automatically assign crew members to trips of one or more vehicles to form one or more rosters for the crew members. The control unit(s) is further configured to automatically reconfigure one or more of the trips in response to determining one or more conflicts between the one or more of the trips and availability of the crew members for the one or more of the trips. The control unit(s) is configured to automatically reconfigure the one or more trips by reconfiguring the one or more trips into a plurality of sub-trips.

### CROSS-REFERENCE TO RELATED APPLICATION

This application is a continuation-in-part of U.S. Pat. Application No. 17/683,458, filed Mar. 1, 2022, entitled “Systems and Methods for Scheduling Resources,” which is hereby incorporated by reference in its entirety.

### FIELD OF THE DISCLOSURE

Examples of the present disclosure generally relate to systems and methods for scheduling resources, such as personnel, aircraft, and the like for services, such as flights of aircraft between various airports, and more particularly to systems and methods for automatically determining crew rosters for trips, such as flights of the aircraft between the airports.

### BACKGROUND OF THE DISCLOSURE

Aircraft are used to transport passengers and cargo between various locations. Numerous aircraft depart from and arrive at a typical airport every day.

Airline operators schedule various resources for flights over a period of time. For example, flight crews including pilots and flight attendants, aircraft, and the like are scheduled for numerous trips, which can include multiple flights. As an example, a trip from an airport in St. Louis, Missouri to Dublin, Ireland may include a first flight from St. Louis, Missouri to Chicago, Illinois, a second flight from Chicago, Illinois to New York, New York, and a third flight from New York, New York to Dublin, Ireland. The trip including all of the different flights may span multiple days.

Various scheduling rules set limits for the scheduling of resources. As an example, pilots are limited to flying a certain number of hours in a day, a certain amount of block time (that is, the time when a block is removed from a wheel of an aircraft at a gate of an airport until a time that a block is put back on the wheel at another gate of another airport), and the like. As another example, certain maintenance procedures for an aircraft are required after a certain number of flight hours. Various scheduling rules are set by various airline operators, regulatory agencies such as the Federal Aviation Administration (FAA), labor unions, and the like. As can be appreciated, the process of scheduling hundreds of thousands of resources for different entities (including employees, vehicles, maintenance, and the like) according to hundreds if not thousands of different scheduling rules for such entities can be labor and time intensive. Indeed, such scheduling may not be able to be adequately performed by human beings, as such could take weeks if not months.

Accordingly, computers can be used to facilitate scheduling of resources. Rule Application Value Evaluator (RAVE) is a proprietary business rules engine. In particular, RAVE is a domain specific functional computer language that is used to express rules for scheduling. However, RAVE typically provides a narrow interface that checks hundreds of millions of possible scheduling options. In short, known scheduling methods generate millions of scheduling permutations that are checked against various scheduling rules using RAVE. Many of the permutations are rejected based on the rules. Such a trial and error method leads to thousands, if not millions, of rejected scheduling options, which consumes computing power and time. Indeed, a typical RAVE checking method can take days to perform, thereby consuming vast amounts of computing power.

Airline crew planning is typically split into two phases, crew pairing and crew rostering. In crew pairing, a set of anonymous trips are created, with a series of flights starting and ending at a specific crew base. In crew rostering, created trips are assigned to individual crew members. As each trip starts at a crew base, availability of crew members at different bases must be accounted when creating trips in crew pairing. For bases containing numerous crew, it can be enough to put daily limits on the amount of trips flown from that base.

Currently, airline planners are often forced into a manual or iterative process to deal with certain crews. For example, while a particular trip (which can include multiple flights spanning one or more days) may be determined, a crew for such trip may not be available for such trip. A particular airline may have only a certain number of crew members that are available for such trip. As another example, the airline may have only a certain number of pilots trained and certified to fly a particular type of aircraft that is available for one or more flights of the trip. As another example, in certain countries, only a certain number of crew members may be fluent in associated languages. In such scenarios, the trip as initially scheduled may not be able to be properly staffed. Therefore, an individual typically needs to review any resulting conflict, and manually determine one of more alternatives to ensure that crew members are assigned to the different flights. As can be appreciated, such a process is complex, labor intensive, and time-consuming.

### SUMMARY OF THE DISCLOSURE

A need exists for a system and a method for efficiently and effectively scheduling resources, such as for trips (for example, flights, train or bus journeys, and/or the like). Further, a need exists for a system and a method that improves efficiency of business rules engine methods for determining schedules. Further, a need exists for a system and a method for determining a roster of crew members for various legs of a trip, such as different flights between two different airports.

With those needs in mind, certain examples of the present disclosure provide a system including one or more control units including one or more processors. The one or more control units is configured to automatically assign crew members to trips of one or more vehicles to form one or more rosters for the crew members.

In at least one example, the one or more control units is further configured to automatically reconfigure one or more of the trips in response to determining one or more conflicts between the one or more of the trips and availability of the crew members for the one or more of the trips. In at least one further example, the one or more control units is configured to automatically reconfigure the one or more trips by reconfiguring the one or more trips into a plurality of sub-trips. As another example, the one or more control units is configured to reconfigure trips by generating new trips (instead of generating sub-trips based on initially determined trips).

The one or more of the trips can include a plurality of legs spanning a plurality of days. The trips are anonymous before the one or more control units automatically assign the crew members.

In at least one example, a plurality of rosters can be determined, as described herein. The one or more control units can be further configured to determine a preferred roster among the plurality of rosters. The one or more control units can be further configured to automatically select the preferred roster.

In at least one example, the one or more control units is further configured to automatically determine the one or more trips.

In at least one example, the system also includes a user interface having a display. The user interface is in communication with the one or more control units. The one or more control units is further configured to show the one or more rosters (and one or more trips) on the display.

Certain examples of the present disclosure provide a method including automatically assigning, by one or more control units including one or more processors, crew members to trips of one or more vehicles to form one or more rosters for the crew members.

Certain examples of the present disclosure provide a non-transitory computer-readable storage medium comprising executable instructions that, in response to execution, cause one or more control units comprising a processor, to perform operations comprising: automatically determining one or more conflicts between one or more of trips of one or more vehicles and availability of crew members; automatically reconfiguring the one or more of the trips in response to said determining; and automatically assigning the one or more trips to the crew members to form one or more rosters for the crew members.

### BRIEF DESCRIPTION OF THE DRAWINGS

FIG. 1 illustrates a simplified chart of availability of two crew members during a week, according to an example of the present disclosure.

FIG. 2 illustrates a schematic block diagram of a system for scheduling resources, according to an example of the present disclosure.

FIG. 3 illustrates a flow chart of a method for scheduling resources, according to an example of the present disclosure.

FIG. 4 illustrates a chart of execution time in relation to cost for a system for scheduling resources, according to an example of the present disclosure.

FIG. 5 illustrates a chart of execution time in relation to cost for a system for scheduling resources, according to an example of the present disclosure.

FIG. 6 illustrates a perspective front view of an aircraft, according to an example of the present disclosure.

FIG. 7 illustrates a flow chart of a method, according to an example of the present disclosure.

FIG. 8 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

In at least one example, systems and methods are configured to generate scheduling options for resources of a service. The resources can be individuals, such as members of a flight crew (for example, pilots). The resources can be scheduled. For example, a specific individual can be scheduled. A resource constraint relates to the resource. For example, a resource constraint for a pilot can be block time in a predetermined time period (such as a month), number of flights flown in a predetermined time period, and the like.

Examples of the present disclosure provide systems and methods that are configured to ensure that trips generated in crew pairing are efficient and assignable to rosters. The systems and methods are configured to automatically account for information about the crew rosters that the trips are to be assigned, as well as rostering rules and costs. The systems and methods provide efficient and effective crew planning for trips.

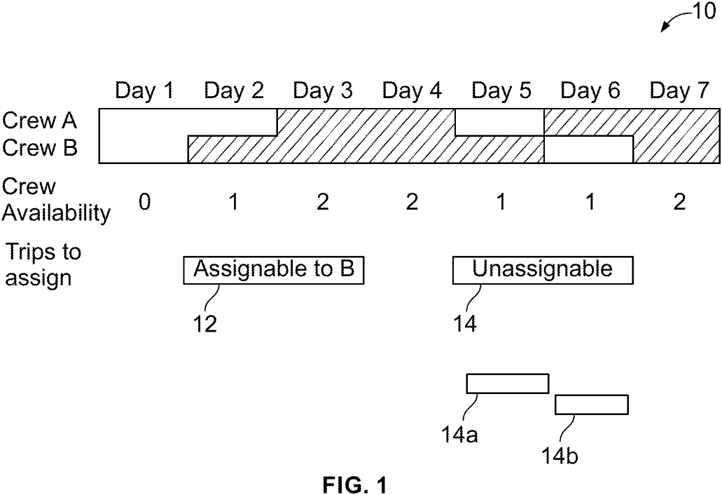

FIG. 1 illustrates a simplified chart 10 of availability of two crew members during a week, according to an example of the present disclosure. For the sake of clarity and simplicity, the chart 10 shows only two crew members - crew member A and crew member B. The chart 10 shows availability for an entire crew, such as a crew having crew member A and crew member B. There may be enough crew members on an aggregate level. However, sometimes, generated trips do not fit with respect to crew availability. The crew members can be vehicle operators, such as pilots, attendants, such as flight attendants, and/or the like. It is to be understood that a crew can include many more crew members than just two. For example, a crew can include ten, twenty, thirty, forty, fifty, or more crew members. Additionally, the time period for the chart can be shorter or longer than a week. As an example, the time period can be a month, year, or longer.

Initially, trips are generated, such as by a scheduling control unit (for example, the scheduling control unit 102 shown in FIG. 1), which can be or otherwise include a trip generator. The trips include a departure destination, such as a first airport, and an arrival destination, such as a second airport. Each trip can include multiple legs between the departure destination and the arrival destination. For example, a particular trip can include three or more legs.

As shown in FIG. 1, two trips 12 and 14 have been determined (for example, generated by the scheduling control unit 102). Each trip 12 and 14 is a work unit that is to be assigned between the different crew members A and B. The trip 12 spans between Day 2 and Day 3, while the trip 14 spans between Day 5 and Day 6. Crew member A is unavailable for assignment on Days 1, 2, and 5. Crew member B is unavailable for assignment on Days 1 and 6. FIG. 1 further shows crew availability on the different days. For example, there is no crew availability on Day 1.

Crew member B is available to be assigned to trip 12. In particular, trip 12 spans between Days 2 and 3, and Crew member B is available for rostering on those two days.

However, trip 14 spans between Days 5 and 6. Crew member B is available on Day 5, but not on Day 6. Conversely, Crew member A is available on Day 6, but not Day 5. As such, the trip 14 is unassignable (that is, a conflict exists between the determined trip and availability of the crew to be assigned to the determined trip). Therefore, as described herein, one or both of the scheduling control unit, and/or a rostering control unit analyzes the availability of the Crew members A and B, and automatically reconfigures (for example, automatically modifies) the trip 14 into a sub-trip 14a and a sub-trip 14b. The control unit(s) then assigns the sub-trip 14a to Crew member B, and the sub-trip 14b to Crew member A.

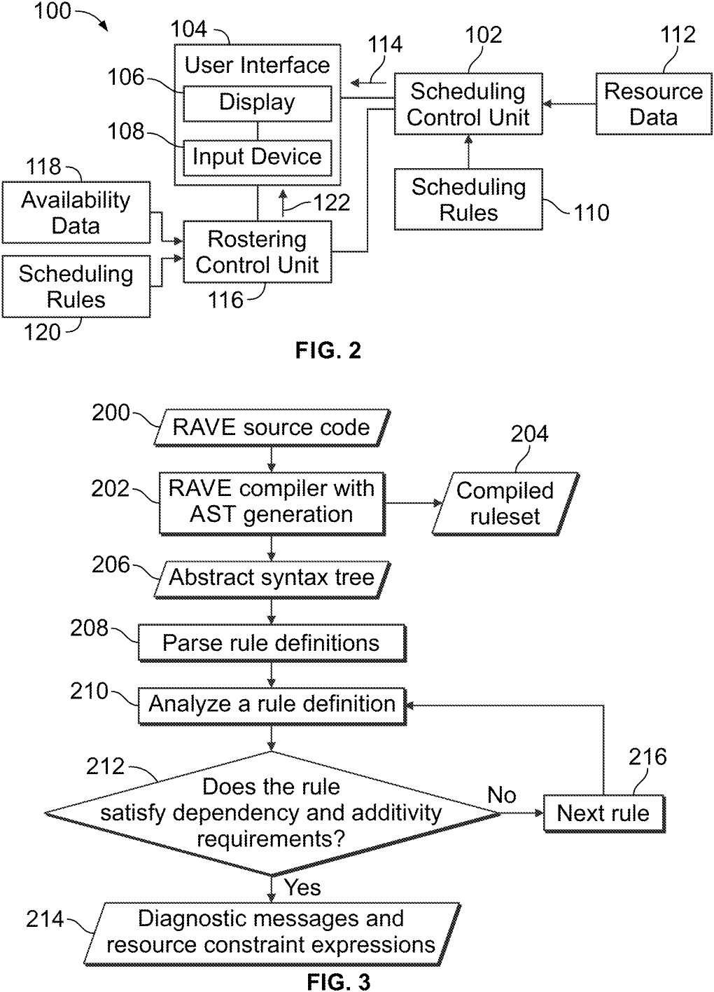

FIG. 2 illustrates a schematic block diagram of a system 100 for scheduling resources, according to an example of the present disclosure. Examples of the resources including personnel, equipment, vehicles, and/or the like. For example, the personnel can be pilots and flight attendants for an aircraft. As another example, the personnel can be operators of vehicles, such as trains, buses, or the like. As another example, the personnel can be medical staff within one or more medical facilities, such as hospitals. As another example, the personnel can be wait staff at restaurants.

The system 100 includes a scheduling control unit 102 in communication with a user interface 104, such as through one or more wired or wireless connections. The user interface 104 includes a display 106, such as an electronic monitor or screen, television, or the like, and an input device 108, such as may be or include a keyboard, mouse, stylus, touchscreen interface, and/or the like. In at least one example, the user interface 104 is part of a computer workstation, such as can include the scheduling control unit 102. As another example, the user interface 104 can be a handheld device, such as a smart phone, smart tablet, or the like.

The scheduling control unit 102 receives scheduling rules 110 and resource data 112. The scheduling rules 110 and the resource data 112 can be input into the scheduling control unit 102, such as via the user interface 104, another computer, and/or the like. In at least one example, the scheduling control unit 102 receives the scheduling rules 110 and the resource data 112 from a network, such as a private network, a public network, the Internet, and/or the like.

The resource data 112 includes data regarding all of the resources that are to be scheduled. Examples of the resources include human beings, such as vehicle operators (such as pilots and flight attendants), maintenance crew, vehicles, and/or the like.

The scheduling rules 110 include resource constraints (for example, upper and/or lower limits) for scheduling the resources. As an example, a scheduling rule 110 is a certain amount of block time that can be flown by a pilot in a day. For example, a scheduling rule 110 dictates that a pilot cannot fly more than 8 hours of block time in a day. As another example, a scheduling rule 110 is a pilot can fly a certain number of flight legs (such as four) in a day. As another example, a scheduling rule 110 is that a pilot must fly a certain number of flights in a given month (such as at least five flights per month). The scheduling rules 110 can be determined by a particular entity, such as an airline operator, a regulator agency, such as the FAA, a labor union, and/or the like. The scheduling rules 110 can be determined by multiple entities and dictate upper and/or lower limits for various aspects for scheduling the resources.

The system 100 also includes a rostering control unit 116 in communication with the user interface 104, and the scheduling control unit 102 through one or more wired or wireless connections. In at least one example, the rostering control unit 116 is separate and distinct from the scheduling control unit 102. As another example, the scheduling control unit 102 and the rostering control unit 116 are part of a common computing or processing device. The system 100 can also include a separate and distinct optimization control unit, or each of the scheduling control unit 102 and the rostering control unit 116 can include optimization capability. That is, the optimization can be performed by scheduling control unit 102 and/or the rostering control unit 116. For example, the scheduling control unit 102 and the rostering control unit 116 can be part of a single processor, integrated circuit, and/or the like. In at least one example, a single control unit can perform the operation of both the scheduling control unit 102 and the rostering control unit 116. As described herein, the scheduling control unit 102 is configured to determine trips (such as one or more legs of a journey between a departure location and an arrival location), and the rostering control unit 116 receives data regarding the trips, and determines a roster for crew members to assign to such trips.

The rostering control unit 116 receives availability data 118 for the crew members (such as shown in FIG. 1). The availability data 118 can be within a memory of, and/or in communication with, the rostering control unit 116. The rostering control unit 116 also receives scheduling rules 120 for the crew members. The scheduling rules 120 can also be within a memory of, and/or in communication with, the rostering control unit 116. The scheduling rules 120 can be the same as the scheduling rules 110. In at least one example, the rostering control unit 116 receives the scheduling rules 110, but not the scheduling rules 120.

The availability data 118 and the scheduling rules 120 (or optionally 110) can be input into the rostering control unit 116, such as via the user interface 104, another computer, and/or the like. In at least one example, the rostering control unit 116 receives the availability data 118 and the scheduling rules 120 from a network, such as a private network, a public network, the Internet, and/or the like.

In operation, the scheduling control unit 102 analyzes the scheduling rules 110 to identify the various resource constraints embedded within or otherwise part of the scheduling rules 110. As noted, the limits can be upper limits (for example, a pilot cannot log more than 8 hours of block time in a day), and/or lower limits (for example, a pilot must fly at least five flights in a month). The scheduling control unit 102 identifies the various limits within the scheduling rules 110. After determining the various limits within the scheduling rules 110, the scheduling control unit 102 applies the scheduling rules to the resource data 112 to determine various schedule options for the resources as set forth in the resource data 112. However, by identifying the limits within the scheduling rules 110, the scheduling control unit 102 refrains from generating schedule options that violate (for example, are in excess of upper limits or are below lower limits) the limits. In this manner, the scheduling control unit 102 efficiently determines the schedule options in a much faster manner than if all possible scheduling permutations were generated. As such, computing time and power are conserved, and the scheduling control unit 102 vastly improves the efficiency and operation of a business rules engine, such as RAVE.

The scheduling control unit 102 determines the trips based on the aforementioned constraints. Referring to FIGS. 1 and 2, the scheduling control unit 102 determines the trips 12 and 14. At this point, the trips 12 and 14 are anonymous in that the Crew members A and B have not be specifically assigned to the trips 12 and 14.

After the scheduling control unit 102 determines the trips 12 and 14, the rostering control unit 116 receives data, such as from the scheduling control unit 102, indicative of the trips 12 and 14. The rostering control unit 116 automatically analyzes the trips 12 and 14 (without human intervention), and determines if there are any conflicts between the trips 12 and 14 and the availability of the Crew members A and B. In this case, the rostering control unit 116 assigns trip 12 to Crew member B, but determines the trip 14 is unassignable. The rostering control unit 116 further determines that Crew member B is available on Day 5, and that Crew member A is available on Day 6. In response, the rostering control unit 116 automatically splits the trip 14 into the sub-trip 14a and the sub-trip 14b. Next, the rostering control unit 116 automatically assigns the sub-trip 14a to Crew member B, and the sub-trip 14b to Crew member A, thereby satisfying the rostering for all legs of the trip 14, as originally determined by the scheduling control unit 102. The scheduling control unit 102 further analyzes the scheduling rules 120 (or optionally 110) to determine that the determined roster for the Crew members A and B does not violate any such rules.

In at least one example, the rostering control unit 116 receives the trips 12 and 14 from the scheduling control unit 102. The rostering control unit 116 then operates to create one or many rosters for crew members A and B. For crew member B, the rostering control unit 116 creates a roster with trip 12 assigned, but there is no way to assign trip 14 to a crew member. Hence the input to a control unit (such as the rostering control unit 116 or a separate optimization control unit) includes a roster for crew member B with trip 12 assigned, trip 14 unassigned, and an option having trip 12 unassigned. The control unit then selects a combination of trips and rosters that cover all the flights. For example, the control unit must select trip 14 unassigned (since there are no options) and covers cover trip 12 by selecting the roster for crew B. The control unit also collects feedback information for the scheduling control unit 102, which prompts the scheduling control unit 102 to generate alternative trips that cover the flights in trip 14, because it was not possible to roster trip 14. In this example, the rostering control unit 116 may not split or reconfigure any trips. Instead, the scheduling control unit 102 may split or reconfigured trips as a response to the feedback received from the optimization routine.

In at least one example, the rostering control unit 116 may not modify any trips and/or select trips to be presented to the user. Instead, the rostering control unit 116 may create new alternative rosters for crew given a set of available trips. The scheduling control unit 102 and the rostering control unit 116 can cooperate to simultaneously select an optimal combination of trips and rosters. Optionally, another separate and distinct optimization control unit simultaneously select an optimal combination of trips and rosters. In such an example, a separate and distinct optimization control unit can be in communication with both the scheduling control unit 102 and the rostering control unit 116.

In at least one example, the rostering control unit 116 may not modify trips. Instead, alternative trips are generated by the scheduling control unit 102 in a subsequent iteration based on feedback from an optimization routine. The rostering control unit 116 then receives the alternative trips, and the process repeats.

In at least one example, the rostering control unit 116 determines a plurality of rosters for crew members, such as Crew members A and B. The plurality of rosters can include reconfigured (for example, modified) trips or sub-trips, as described. The plurality of rosters satisfy all scheduling rules and availability for the Crew members A and B. The rostering control unit 116 can then analyze the plurality of rosters. At least control unit (such as a separate optimizer control until, and/or an optimization aspect of the rostering control unit 116) then selects a preferred roster for each crew member. In at least one example, the preferred roster provides optimal harmony among all of the crew members. The optimal harmony is determined by the scheduling rules 120 (and/or 110), ease of travel to particular destinations for the individual crew members, and/or the like.

As described herein, the system 100 is configured to determine rosters of crews, which include a plurality of crew members. The rosters can include information about all activities from a previous planning period for specific crew members, as well as pre-assigned activities that are required by particular scheduling rules, such as vacations, health checks, certain trips, and/or the like.

As described herein, the system 100 includes one or more control units (such as the rostering control unit 116) configured to automatically (without human intervention) assign crew members to trips (which can include multiple legs over multiple days) of one or more vehicles (such as aircraft) to form a roster for the crew members. In at least one example, the control unit(s) is further configured to automatically reconfigure (for example, modify) one or more of the trips in response to determining one or more conflicts between the one or more trips and availability of the crew members for the one or more trips. That is, a conflict arises if there is no availability among the crew members to be assigned such a trip, as originally determined (such as by the scheduling control unit 102). In at least one further example, the control unit(s) is configured to automatically reconfigure the one or more trips by reconfiguring the one or more trips into a plurality of sub-trips (for example, component portions of the originally determined trip).

In at least one example, a RAVE module operating according to RAVE source code extended to determine the legality and cost of complete crew rosters, In addition to a trip generator (for example, the scheduling control unit 102), the system 100 also includes a roster generator (for example, the rostering control unit 116) configured to generate rosters for crews. The rosters generated for a certain crew can include historic and mandatory (for example, pre-assigned) activities together with different selections of trips. The legality and cost of such rosters can be computed using the extended RAVE module. The rostering control unit 116 discards illegal rosters (that is, those rosters that violate one or more scheduling rules, and are therefore invalid).

In at least one example, the rostering control unit 116 is configured to select a subset of trips together with a subset of crew rosters so that a single roster is selected for each crew and each flight is covered by a trip (either assigned to a crew roster or left unassigned). In a post-processing step, the rostering control unit 116 can save one or more of the determined rosters.

In at least one example, the scheduling control unit 102 operates as a trip generator. In this manner, the scheduling control unit 102 generates legal and efficient trips, which include numerous options and alternatives for trips of each flight that can be planned. The rostering control unit 116 provides a roster generator that generates legal and efficient rosters for the crew members based on trips generated by the scheduling control unit 102. The rostering control unit 116 generates numerous options and alternatives for rosters for crew members. One or both of the scheduling control unit 102 and/or the rostering control unit 116 is further configured as an optimizer to select a subset/combination of trips and rosters such that each flight is covered by either a (unassigned) trip or a roster. Each crew can be assigned exactly one roster, as determined by the rostering control unit 116. The scheduling control unit 102 and/or the rostering control unit 116 can also collects information that is used to guide the scheduling control unit 102 and the rostering control unit 116 in a next iteration of the process described herein.

Prior to the systems and methods described herein, due to size and complexity, runtimes for computer-based scheduling could be several days for a large crew group. A known method generates new rosters by finding shortest paths in a trip network. However, some shortest paths do not comply with permissible rules. An allowability rate (that is, the rate at which a path is permissible according to a rule) can be increased by augmenting a trip network with resource constraints that correspond to additive permissibility rules. Typically, resource constraints are written manually in RAVE as a part of customer specific configuration. Finding suitable rules and deducing the constraints is a challenging and error-prone task. Accordingly, examples of the present disclosure provide systems and methods (such as the system 100 shown in FIG. 1) automatically detect additive rules through static RAVE code analysis, and then generate new source code for the corresponding resource constraint.

The system 100 achieves computational performance and flexibility. Column generation is a known method for solving a weighted fair share rostering problem. One of the steps of the method is generating new rosters by finding shortest paths in a trip network. After finding a shortest path in the network, an optimizer checks the permissibility of the corresponding roster (in relation to predefined rules). If the roster is permissible, a new path is generated, but this time with impermissible paths excluded. However, solving the shortest path problem several times to get a permissible roster decreases performance considerably.

To avoid impermissible paths, the scheduling control unit 102 and/or the rostering control unit 116 is augmented with resource constraints which correspond to RAVE rules. The resource constraints are limits (either upper or lower limits) identified in the rules. Scheduling and/or rostering options that violate (for example, exceeding an upper limit or being less than a lower limit) are not generated by the scheduling control unit 102 and/or the rostering control unit 116. Not every rule can be expressed as a resource constraint, but a significant portion can. As an example, the rule satisfies the following: First, the rule condition has a form left_hand_side and right_hand_side. Second, the expressions for right_hand_side and rule validity may depend on a crew and a bid group, but may not depend on a roster or trips in the roster. Third, the expression for left_hand_side may not depend on a crew or a bid group, but should be additive over trips in the roster (for example, consumption of a roster is a sum of the consumptions of trips in the roster). A special case is an edge resource constraint, where left_hand_side does not have to be additive over trips, but is additive over edges (connections between two adjacent trips).

Examples of the present disclosure provide systems and methods for solving complex crew resource optimization problems in a computationally efficient manner using resource constraints combined with a business rules engine, such as RAVE. The systems and methods described herein address the currently resource-heavy and manual process of identifying and implementing customer-specific resource constraints for crew resource optimization.

In at least one example, the scheduling control unit 102 and/or the rostering control unit 116 is configured to determine the resource constraints by analyzing an abstract syntax tree of business engine scheduling source code, identify additive rules, and generate resource constraint definitions as business engine scheduling expressions. For example, the scheduling control unit 102 and/or the rostering control unit 116 analyzes an abstract syntax tree of business engine scheduling and/or rostering source code (such as RAVE source code), finds additive rules and generates resource constraint definitions as RAVE expressions. In at least one example, the scheduling control unit 102 and/or the rostering control unit 116 parses the abstract syntax tree of each RAVE rule. The scheduling control unit 102 and/or the rostering control unit 116 parses the syntax tree and checks the dependency of the rule condition as well as the dependencies of the RAVE variables used in the rule. If the condition statement and the RAVE variables fulfill the conditions, the rule can be written as a resource constraint. Next, the scheduling control unit 102 and/or the rostering control unit 116 generates the RAVE code for the identified resource constraints by parsing the abstract syntax trees for the identified rules and translating them back to RAVE code.

In at least one example, the scheduling control unit 102 outputs scheduling data 114 to the user interface 104. The scheduling data 114 includes the trips. The scheduling data 114 includes the scheduling options for the resources identified in the resource data 112. The user interface 104 may show at least portions of the scheduling data 114 on the display 106. The user interface 104 has an electronic display 106. The user interface is in communication with the scheduling control unit 102. The scheduling control unit 102 is configured to show one or more of the scheduling options on the electronic display 106.

In at least one example, the rostering control unit 115 outputs roster data 122 to the user interface 104. The roster data 122 includes one or more rosters for scheduled trips (which may include sub-trips, as described herein). The roster data 122 can include multiple roster options for the crew members. The rostering control unit 116 (such as an optimization portion thereof), or a separate and distinct control unit (such as an optimization control unit) can identify a preferred roster among the plurality of roster options. In at least one example, the rostering control unit 116 automatically selects the preferred roster. As another example, the rostering control unit 116 identifies the preferred roster, and allows an individual to select among the roster options. The user interface 104 may show at least portions of the roster options on the display 106.

Various operations can be automatically performed based on selected scheduling and roster options. For example, aircraft can be automatically staffed and/or operated based on schedules from the scheduling and/or roster options, as determined by the scheduling control unit 102 and/or the rostering control unit 116. In at least one example, the scheduling control unit 102 and/or the rostering control unit 116 automatically selects schedules and/or rosters from the scheduling and/or roster options based on one or more parameters (for example, lowest cost of labor, regular number of work days for all personnel, least amount of off time, and/or the like). In at least one example, the scheduling control unit 102 automatically selects schedules from the scheduling options for all of the resources and one or more systems, such as vehicles, having one or more operations that are automatically operated based on the automatically selected schedules. Optionally, the scheduling control unit 102 and/or the rostering control unit 116 may not automatically select schedules and/or rosters from the scheduling and/or roster options. Also, optionally, operations may not be automatically performed based on selected schedules and/or rosters.

As described herein, the system 100 includes the scheduling control unit 102 configured to generate scheduling options for resources of a service, such as flight crew, maintenance crew, gate agents, and the like of flights of aircraft. For example, the resources include pilots, flight attendants, and a plurality of aircraft, and the service includes flights of the plurality of aircraft between various airports. The scheduling control unit 102 is configured to analyze scheduling rules for the resources, and determine resource constraints as dictated by the scheduling rules. The resource constraints include one or both of upper limits or lower limits of the scheduling rules. The scheduling control unit 102 generates the scheduling options in accordance with the resource constraints. That is, the scheduling control unit 102 refrains from generating any scheduling option that violates the resource constraints.

As described herein, the system 100 includes the rostering control unit 116 configured to automatically determine one or more rosters for a plurality of crew members based on trips, such as can be determined by the scheduling control unit 102. The rostering control unit 116 is configured to automatically (without human intervention) analyze the trips and automatically (without human intervention) determine one or more rosters for the crew members based on the trips. In at least one example, if the crew members are unavailable for one or more trips (that is, the trip(s) conflict with crew availability), the rostering control unit 116 automatically modifies the trip(s) into a plurality of sub-trips that are assignable to one or more of the crew members. The rostering control unit 116 then assigns the available crew members to the sub-trips.

In at least one example, a single control unit can perform the operations of the scheduling control unit 102 and the rostering control unit 116. For example, the scheduling control unit 102 and the rostering control unit 116 can be part of a common control unit. As such, the system 100 includes one or more control units configured to operate as described herein.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the scheduling control unit 102 and the rostering control unit 116 may be or include one or more processors that are configured to control operation, as described herein.

The scheduling control unit 102 and the rostering control unit 116 are configured to execute a set of instructions that are stored in one or more data storage units or elements (such as one or more memories), in order to process data. For example, the scheduling control unit 102 and the rostering control unit 116 may include or be coupled to one or more memories. The data storage units may also store data or other information as desired or needed. The data storage units may be in the form of an information source or a physical memory element within a processing machine.

The set of instructions may include various commands that instruct the scheduling control unit 102 and the rostering control unit 116 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the scheduling control unit 102 and the rostering control unit 116. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the scheduling control unit 102 and the rostering control unit 116 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 3 illustrates a flow chart of a method for scheduling resources, according to an example of the present disclosure. Referring to FIGS. 2 and 3, at 200, RAVE source code is generated. The scheduling control unit 102 receives RAVE source code at 202. In at least one example, the scheduling control unit 102 includes a RAVE complier with abstract syntax tree generation. At 204, the scheduling control unit 102 generates a complied ruleset.

At 206, the scheduling control unit 102 analyzes the abstract syntax tree of the RAVE source code to identify rule definitions (that is, the rules). At 208, the scheduling control unit 102 parses the rule definitions. At 210, the scheduling control unit analyzes a rule definition 210. At 212, the scheduling control unit 102 determines if the rule satisfies dependency and additivity requirements. For example, an additivity requirement is in relation to an upper limit. As an example, a rule requires that a pilot does not exceed 8 hours block time in a day. As another example, a rule requires at least 5 flights in a month. As another example, a rule requires no more than 4 flight legs in a day. If, at 212, the rules satisfied dependency and additivity requirements, the method proceeds to 214, at which the scheduling control unit 102 outputs diagnostic messages, and resource constraint expressions. If, however, the rule does not satisfy the additivity and dependency requirements, the method proceeds to 216, at which the scheduling control unit analyzes the next rule, and the method returns to 210.

A dependency rule relates to what a specific expression depends upon. For example, block time is summed for each trip in a predetermined time period, such as a month. The block time of each trip depends only on the trip itself and the rule can be expressed as a resource constraint. As another example, an individual may fly at most two night trips in a month. A trip is considered a night trip if an individual works across a predefined time in personal acclimatised time (commonly called one’s body clock). The personal acclimatised time is a function of the time of nightly rest for a past week. Even though the rule can be expressed as a sum of a per trip value, the value that is summed (if a trip is considered a night trip) depends on more than the trip itself or its immediate predecessor. Hence, the trip value may not be pre-computed as it depends on the surrounding schedule and cannot be expressed as a sum of something purely trip-dependent. Therefore, such rule cannot be expressed as a simple additive resource constraint.

As shown and described, in at least one example, the scheduling control unit 102 analyzes the abstract syntax tree of business engine scheduling source code (such as RAVE source code), identifies additive rules, and generates resource constraint definitions as business engine scheduling (for example, RAVE) expressions. In at least one example, the scheduling control unit 102 parses the abstract syntax tree of each business engine scheduling (for example, RAVE) rule. The scheduling control unit 102 parses the abstract syntax tree and checks the dependency of the rule condition as well as the dependencies of business engine scheduling variables used in the rule. If the condition statement and the business engine scheduling variables fulfill predefined conditions, the rule can be written as a resource constraint. In a final step, the scheduling control unit 102 generates code for the identified resource constraints by parsing the abstract syntax trees for the identified rules and translating them back to the business engine scheduling source code.

Examples of the subject disclosure provide systems and methods that allow large amounts of data to be quickly and efficiently analyzed by a computing device. For example, the scheduling control unit 102 and the rostering control unit 116 can analyze various aspects of resources, trips, and scheduling rules. As such, large amounts of data, which may not be discernable by human beings, are being tracked and analyzed. The vast amounts of data are efficiently organized and/or analyzed by the scheduling control unit 102 and the rostering control unit 116, as described herein. The scheduling control unit 102 and the rostering control unit 116 analyze the data in a relatively short time in order to quickly and efficiently determine scheduling and rostering options in a relatively short time. A human being would be incapable of efficiently analyzing such vast amounts of data in such a short time. As such, examples of the subject disclosure provide increased and efficient functionality, and vastly superior performance in relation to a human being analyzing the vast amounts of data.

Identifying rules satisfying various requirements (for example, upper and lower limits), and writing corresponding resource constraints is a non-trivial, time-consuming and error-prone task for humans, yet essential to get maximum performance in relation to a column generation method. Very few people have the required skills to effectively perform such tasks. The systems and methods described herein automatically (that is, without human intervention), efficiently, and effectively perform such tasks.

In at least one embodiment, components of the system 100, such as the scheduling control unit 102 and the rostering control unit 116, provide and/or enable a computer system to operate as a special computer system for determining schedules and rosters. The scheduling control unit 102 and the rostering control unit 116 greatly improve upon business engine scheduling software by greatly decreasing computing time and power to determine schedules for various resources and rosters for crew members.

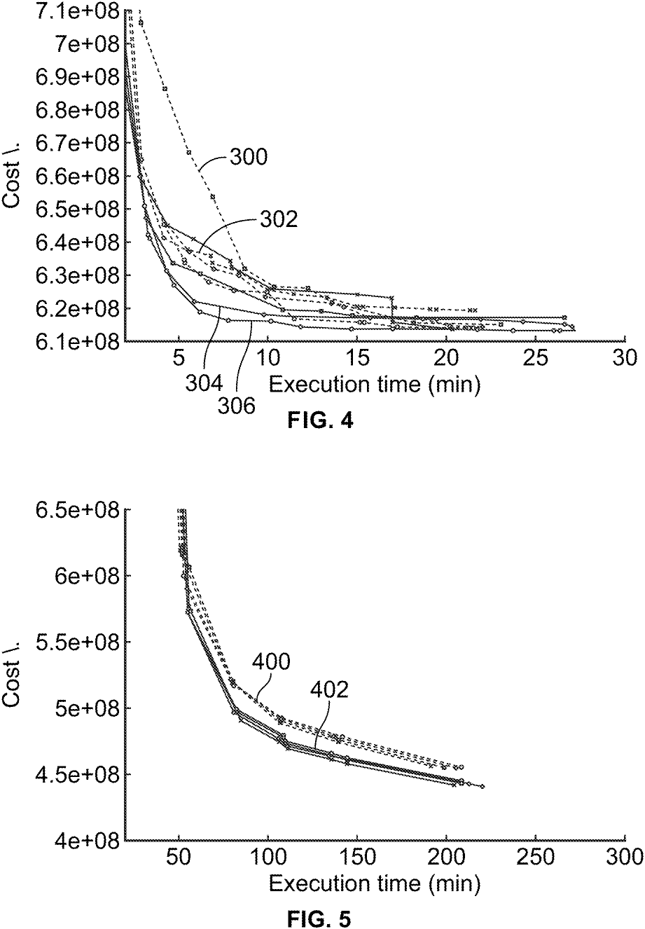

FIG. 4 illustrates a chart of execution time in relation to cost for a system for scheduling resources, according to an example of the present disclosure. As shown in FIG. 4, examples of the present disclosure provide systems and methods that vastly improve time and costs by adding identified resource constraints to the model. The curves 300 and 302, for example, correspond to different permutations of the same run (that is, they use different random seeds which typically result in different solution paths). The curves 304 and 306, for example, correspond to the same runs but with the resource constraints generated by the scheduling control unit 102. It has been found that adding resource constraints provides better solutions faster (notably, the curves 304 and 306 are below the curves 300 and 302).

FIG. 5 illustrates a chart of execution time in relation to cost for a system for scheduling resources, according to an example of the present disclosure. The curves 400 correspond to runs where no resource constraints are used. The curves 402 correspond to runs in which resources constraints (for example, limits identified in the rules -- scheduling options that violate such limits are not generated) are added by the scheduling control unit 102. It has been found that the scheduling control unit 102 determining the resource constraints (that is, the limits of the rules), and using such resource constraints when determining scheduling options provides better solutions.

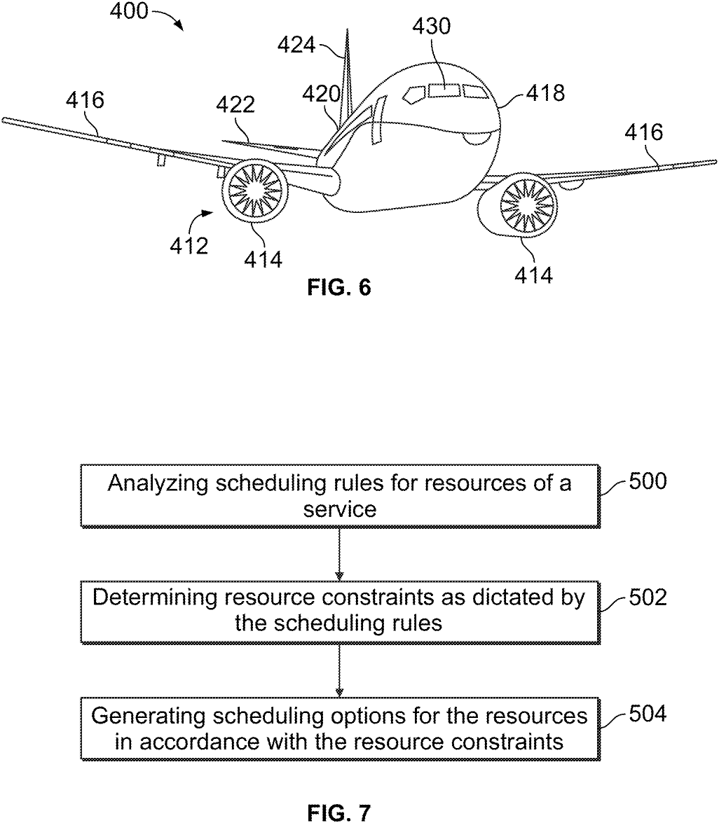

FIG. 6 illustrates a perspective front view of an aircraft 400, according to an example of the present disclosure. The aircraft 400 includes a propulsion system 412 that includes engines 414, for example. Optionally, the propulsion system 412 may include more engines 414 than shown. The engines 414 are carried by wings 416 of the aircraft 400. In other embodiments, the engines 414 may be carried by a fuselage 418 and/or an empennage 420. The empennage 420 may also support horizontal stabilizers 422 and a vertical stabilizer 424. The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 400. It is to be understood that the aircraft 400 can be sized, shaped, and configured differently than shown in FIG. 6.

Referring to FIGS. 1-6, and the scheduling control unit 102 is configured to determine scheduling options for flights of various aircraft, such as the aircraft 400. The rostering control unit 116 is configured to determine rosters for crew members to staff the aircraft schedules for various trips. The scheduling control unit 102 can schedule resources for hundreds or more aircraft. Similarly, the rostering control unit 116 can determine rosters for dozens, hundreds, or more crew members. The aircraft 400 itself can be a resource identified in the resource data. One or more scheduling rules can apply to the aircraft, such as total flight time in a predefined period of time, flight time until a particular maintenance operation, and/or the like.

In at least one other example, the scheduling control unit 102 and/or the rostering control unit 116 are configured to determine scheduling and/or roster options for trips of various other vehicles, such as trains, buses, watercraft, spacecraft, and/or the like. In at least one other example, the scheduling control unit 102 and/or the rostering control unit 116 is configured to determine scheduling options and/or roster options for various other settings, such as staffing within businesses, hospitals, and/or the like.

FIG. 7 illustrates a flow chart of a method, according to an example of the present disclosure. The method includes analyzing 500, by a scheduling control unit including one or more processors, scheduling rules for resources of a service; determining 502, by the scheduling control unit, resource constraints as dictated by the scheduling rules; and generating 504, by the scheduling control unit, scheduling options for the resources in accordance with the resource constraints.

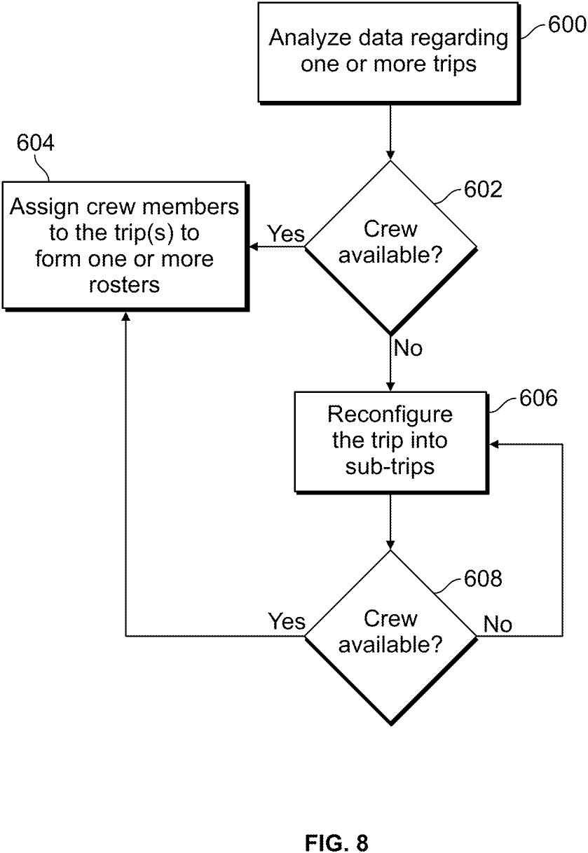

FIG. 8 illustrates a flow chart of a method, according to an example of the present disclosure. The method includes analyzing 600, by one or more control units (such as the rostering control unit 116, shown in FIG. 2), data regarding one or more trips. The trip(s) can be automatically determined, such as by the scheduling control unit 102 (shown in FIG. 1). At 602, the control unit(s) determines if crew members are available for the trip(s). If so, the method proceeds from 602 to 604, at which the rostering control unit 116 automatically (without human intervention) assigns one or more crew members to the one or more trips to form one or more rosters. If, however, crew is not available for the trip(s) at 602 (that is, a conflict exists between the trip(s) and availability of crew members), the rostering control unit 116 automatically (without human intervention) reconfigures the trip(s), such as by generating new trip(s), and/or splitting initially generated trip(s) into sub-trips at 606. At 608, the rostering control unit 116 again determines if crew members are available for the sub-trips. If not, the method returns to 606 (for example, each sub-trip is further reconfigured into another sub-trip or additional sub-trips). If, however, there is crew availability for the sub-trips at 606, the method proceeds from 608 to 604.

In at least one example, trips and rosters are selected simultaneously. Optionally, the trips and rosters can be selected at different times.

Further, the disclosure comprises examples according to the following clauses:

Clause 1. A system comprising:

one or more control units including one or more processors, wherein the one or more control units is configured to automatically assign crew members to trips of one or more vehicles to form one or more rosters for the crew members.

Clause 2. The system of Clause 1, wherein the one or more control units is further configured to automatically reconfigure one or more of the trips in response to determining one or more conflicts between the one or more of the trips and availability of the crew members for the one or more of the trips.

Clause 3. The system of Clause 2, wherein the one or more control units is configured to automatically reconfigure the one or more trips, such as by reconfiguring the one or more trips into a plurality of sub-trips.

Clause 4. The system of any of Clauses 1-3, wherein one or more of the trips includes a plurality of legs spanning a plurality of days.

Clause 5. The system of any of Clauses 1-4, wherein the trips are anonymous before the one or more control units automatically assign the crew members.

Clause 6. The system of any of Clauses 1-5, wherein the one or more rosters comprise a plurality of rosters.

Clause 7. The system of Clause 6, wherein the one or more control units is further configured to determine a preferred roster among the plurality of rosters.

Clause 8. The system of Clause 7, wherein the one or more control units is further configured to automatically select the preferred roster.

Clause 9. The system of any of Clauses 1-8, wherein the one or more control units is further configured to automatically determine the one or more trips.

Clause 10. The system of any of Clauses 1-9, further comprising a user interface having a display, wherein the user interface is in communication with the one or more control units, and wherein the one or more control units is further configured to show the one or more rosters on the display.

Clause 11. A method comprising:

automatically assigning, by one or more control units including one or more processors, crew members to trips of one or more vehicles to form one or more rosters for the crew members.

Clause 12. The method of Clause 11, further comprising:
automatically determining, by the one or more control units, one or more conflicts between one or more of the trips and availability of the crew members; and
automatically reconfiguring, by the one or more control units, the one or more of the trips in response to said determining.

Clause 13. The method of Clause 12, further comprising wherein said automatically reconfiguring comprises automatically reconfiguring the one or more trips, such as by reconfiguring the one or more trips into a plurality of sub-trips.

Clause 14. The method of any of Clauses 11-13, wherein one or more of the trips includes a plurality of legs spanning a plurality of days, and wherein the trips are anonymous before said automatically assigning.

Clause 15. The method of any of Clauses 11-14, wherein the one or more rosters comprise a plurality of rosters.

Clause 16. The method of Clause 15, further comprising determining, by the one or more control units, a preferred roster among the plurality of rosters.

Clause 17. The method of Clause 16, further comprising automatically selecting, by the one or more control units, the preferred roster.

Clause 18. The method of any of Clauses 11-17, further comprising automatically determining, by the one or more control units, the one or more trips.

Clause 19. The method of any of Clauses 11-18, further comprising showing, by the one or more control units, the one or more rosters on a display of a user interface that is in communication with the one or more control units.

Clause 20. A non-transitory computer-readable storage medium comprising executable instructions that, in response to execution, cause one or more control units comprising a processor, to perform operations comprising:
automatically determining one or more conflicts between one or more of trips of one or more vehicles and availability of crew members;
automatically reconfiguring the one or more of the trips in response to said determining; and
automatically assigning the crew members to the one or more trips to form one or more rosters for the crew members.

As described herein, examples of the present disclosure provide systems and methods for efficiently and effectively scheduling resources, such as for trips (for example, flights, train or bus journeys, and/or the like). Further, examples of the present disclosure provide systems and methods that improve efficiency of business rules engine methods for determining schedules. Also, examples of the present disclosure provide systems and methods that automatically determine one or more rosters of crew members, such as for various legs of a trip.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
one or more control units including one or more processors, wherein the one or more control units is configured to automatically assign crew members to trips of one or more vehicles to form one or more rosters for the crew members.

2. The system of claim 1, wherein the one or more control units is further configured to automatically reconfigure one or more of the trips in response to determining one or more conflicts between the one or more of the trips and availability of the crew members for the one or more of the trips.

3. The system of claim 2, wherein the one or more control units is configured to automatically reconfigure the one or more trips by reconfiguring the one or more trips into a plurality of sub-trips.

4. The system of claim 1, wherein one or more of the trips includes a plurality of legs spanning a plurality of days.

5. The system of claim 1, wherein the trips are anonymous before the one or more control units automatically assign the crew members.

6. The system of claim 1, wherein the one or more rosters comprise a plurality of rosters.

7. The system of claim 6, wherein the one or more control units is further configured to determine a preferred roster among the plurality of rosters.

8. The system of claim 7, wherein the one or more control units is further configured to automatically select the preferred roster.

9. The system of claim 1, wherein the one or more control units is further configured to automatically determine the one or more trips.

10. The system of claim 1, further comprising a user interface having a display, wherein the user interface is in communication with the one or more control units, and wherein the one or more control units is further configured to show the one or more rosters on the display.

11. A method comprising:
automatically assigning, by one or more control units including one or more processors, crew members to trips of one or more vehicles to form one or more rosters for the crew members.

12. The method of claim 11, further comprising:
automatically determining, by the one or more control units, one or more conflicts between one or more of the trips and availability of the crew members; and
automatically reconfiguring, by the one or more control units, the one or more of the trips in response to said determining.

13. The method of claim 12, further comprising wherein said automatically reconfiguring comprises automatically reconfiguring the one or more trips by reconfiguring the one or more trips into a plurality of sub-trips.

14. The method of claim 11, wherein one or more of the trips includes a plurality of legs spanning a plurality of days, and wherein the trips are anonymous before said automatically assigning.

15. The method of claim 11, wherein the one or more rosters comprise a plurality of rosters.

16. The method of claim 15, further comprising determining, by the one or more control units, a preferred roster among the plurality of rosters.

17. The method of claim 16, further comprising automatically selecting, by the one or more control units, the preferred roster.

18. The method of claim 11, further comprising automatically determining, by the one or more control units, the one or more trips.

19. The method of claim 11, further comprising showing, by the one or more control units, the one or more rosters on a display of a user interface that is in communication with the one or more control units.

20. A non-transitory computer-readable storage medium comprising executable instructions that, in response to execution, cause one or more control units comprising a processor, to perform operations comprising:
automatically determining one or more conflicts between one or more of trips of one or more vehicles and availability of crew members;
automatically reconfiguring the one or more of the trips in response to said determining; and
automatically assigning the crew members to the one or more trips to form one or more rosters for the crew members.
